(19) United States
(12) Patent Application Publication
(10) Pub. No.: US 2019/0181731 A1
(43) Pub. Date: Jun. 13, 2019

(54) PRODUCTION METHOD FOR STATOR

(71) Applicant: TOYOTA JIDOSHA KABUSHIKI KAISHA, Toyota-shi (JP)

(72) Inventors: Fumitaka YOSHINAGA, Toyota-shi (JP); Kazuaki HAGA, Toyota-shi (JP); Kensuke KOMORI, Toyota-shi (JP); Kiyotaka ONODERA, Susono-shi (JP)

(73) Assignee: TOYOTA JIDOSHA KABUSHIKI KAISHA, Toyota-shi (JP)

(21) Appl. No.: 16/197,018

(22) Filed: Nov. 20, 2018

(30) Foreign Application Priority Data
Dec. 8, 2017 (JP) 2017-236486

(51) Int. Cl. H02K 15/02; H02K 3/34; H02K 3/32; H02K 1/02

(52) U.S. Cl. CPC H02K 15/026; H02K 1/02; H02K 3/325; H02K 3/345

(57) ABSTRACT

An object of the present disclosure is to provide a production method for a stator in which a breakage of the stator core can be prevented when coils are mounted thereon. The present embodiment is a production method for a stator that includes a stator core having a tooth and includes a coil wound around the tooth. The method includes: a step of preparing a stacked body which has the tooth and in which a plurality of plate-like soft magnetic materials each including an amorphous structure are stacked; a step of mounting the coil on the tooth; and a step of, after the coil is mounted, heating the stacked body to a temperature equal to or higher than a crystallization temperature of the soft magnetic materials.

### CROSS REFERENCE TO RELATED APPLICATIONS

The present application claims priority from Japanese patent application JP 2017-236486 filed on Dec. 8, 2017, the content of which is hereby incorporated by reference into this application.

### BACKGROUND

### Technical Field

The present disclosure relates to a production method for a stator.

### Background Art

In the automobile industry, in order to further improve the travelling performance of hybrid automobiles and electric vehicles, high-output, light-weighted, and downsized driving motors have been developed. Also, home appliance manufacturers have addressed further downsizing and performance improvement of rotary electric machines such as motors to be incorporated in various home appliances.

In order to improve the performance of a rotary electric machine, there is a problem of how to reduce a loss occurring inside the machine. In a stator, a core loss (or a high frequency core loss) caused by an eddy current loss or a hysteresis loss occurs, and the motor efficiency and the torque performance are degraded according to these losses.

Therefore, in order to improve the performance of a stator, a soft magnetic material is used for the material of a stator core. As such soft magnetic material, an amorphous-based soft magnetic material and a nanocrystal-based soft magnetic material have been developed, for example. These soft magnetic materials are excellent materials having low loss, high electric resistance, high saturation magnetization and excellent magnetic excitation characteristics. For example, as a developed soft magnetic material, a soft magnetic alloy thin strip having a predetermined composition and a predetermined structure is disclosed in JP Patent Publication (Kokai) 2011-149045 A.

Meanwhile, in production of a stator core, a stacked body as a precursor for a stator core is prepared, and then, the stacked body is annealed at predetermined temperature in order to improve the magnetic characteristics (saturation magnetization) thereof by reducing a core loss. More specifically, first, a soft magnetic material is punched into stator core plates, the stator core plates are stacked, and caulking or welding is performed thereon to produce a stacked body. Next, in order to improve the magnetic characteristics by reducing a core loss, the stacked body is annealed at predetermined temperature, so that crystallization of the soft magnetic material is facilitated. Also, by this annealing, a machining strain generated during pressing can be removed.

### SUMMARY

However, while annealing to facilitate crystallization of the soft magnetic material can result in improvement of the saturation magnetization, the facilitation of crystallization deteriorates the strength of the stator core. If the strength of the stator core is deteriorated, a breakage such as chipping, cracking, or a scratch is easily generated in the stator core (in particular, a tooth thereof) when a coil is mounted on a tooth of the stator core in a post-process. That is, in a step of mounting the coil on the tooth, a load is applied to the stator core when the coil is wound or bent, so that the aforementioned breakage may be generated. Therefore, development of a production method for a stator core in which a breakage of the stator core can be prevented when a coil is mounted thereon is desired.

Therefore, the present disclosure relates to providing a production method for a stator in which a breakage of the stator core can be prevented when a coil is mounted thereon.

One aspect of the present disclosure is as follows:

(1) A production method for a stator that includes a stator core having a tooth and includes a coil wound around the tooth, the method including

a step of preparing a stacked body which has the tooth and in which a plurality of plate-like soft magnetic materials each including an amorphous structure are stacked,

a step of mounting the coil on the tooth, and

a step of, after the coil is mounted, heating the stacked body to a temperature equal to or higher than a crystallization temperature of the soft magnetic materials.

(2) The production method according to (1), wherein

the stacked body is heated by high-frequency current flowing through the coil.

(3) The production method according to (1) or (2), wherein

each of the soft magnetic materials is an amorphous-based soft magnetic material or a nanocrystal-based soft magnetic material including an amorphous structure.

(4) The production method according to (3), wherein

a degree of crystallinity of each of the soft magnetic materials is 0-90%.

According to the present disclosure, a production method for a stator core in which a breakage of the stator core can be prevented when a coil is mounted thereon.

### BRIEF DESCRIPTION OF THE DRAWINGS

FIG. 1 is a schematic diagram illustrating a configuration example of a stator that can be produced by the present embodiment;

FIG. 2 is a schematic perspective view of a stacked body (a precursor for a stator core) formed by stacking a plurality of stator core plates;

FIG. 3 is a schematic perspective view for explaining a step of mounting a coil which is wound in advance, onto a tooth;

FIGS. 4(A) and 4(B) are schematic cross-sectional views for explaining an example of a step of mounting a U-shaped coil member on a tooth, wherein FIG. 4(A) is a schematic cross-sectional view showing a state in which segments are inserted in slots, and FIG. 4(B) is a schematic cross-sectional view showing a state in which, subsequent to the state in FIG. 4(A), lead portions are bent and are welded together;

FIG. 5 is a schematic perspective view of an embodiment in which insulators 14 are disposed in slots between teeth; and

FIG. 6 is a graph showing the tensile strength of an amorphous plate used in Example 1, the tensile strength of a nanocrystal plate (degree of crystallinity: 90%) used in Example 2, and the tensile strength of a nanocrystal plate (degree of crystallinity: 100%) used in Comparative Example 3.

### DETAILED DESCRIPTION

The present embodiment relates to a production method for a stator that includes a stator core having a tooth and includes a coil wound around the tooth, the method including: a step of preparing a stacked body which has the tooth and in which a plurality of plate-like soft magnetic materials each including an amorphous structure are stacked; a step of mounting the coil on the tooth; and a step of, after the coil is mounted, heating the stacked body to a temperature equal to or higher than a crystallization temperature of the soft magnetic materials.

In the present embodiment, after the coil is mounted on the tooth, the stacked body is heated to the predetermined temperature or higher, so that the saturation magnetization is improved. Therefore, since, when the coil is mounted, there is no deterioration in strength caused by heating, a breakage of the stator core can be prevented.

Hereinafter, the present embodiment is described in detail.

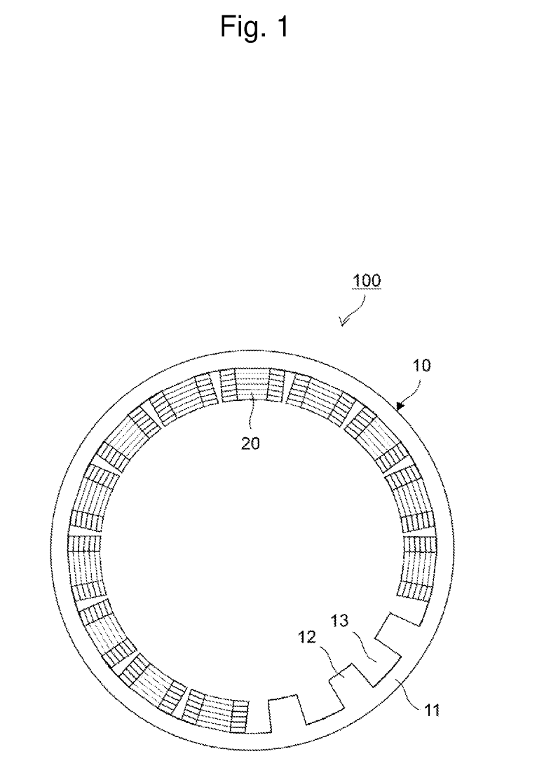

The present embodiment relates to a production method for a stator that includes a stator core having a tooth and includes a coil wound around the tooth. A schematic diagram illustrating a configuration example of the stator is shown in FIG. 1. FIG. 1 is a schematic diagram of a stator 100 for a rotary electric machine, when viewed from the axial direction. In FIG. 1, the configuration is partially omitted for convenience of explanation. The stator 100 has an annular shape as a whole. Hereinafter, the center axis of this annular shape is referred to as “axis”. The axis extends in a direction orthogonal to the paper surface in FIG. 1. A rotor (not illustrated) is disposed inside the stator 100.

The stator 100 includes a stator core 10 and coils 20. The stator core 10 includes an annular yoke 11 and a plurality of teeth 12 extending circumferentially inward from the yoke 11. In FIG. 1, illustration of some of the coils 20 is omitted to clearly show the teeth 12. The teeth 12 are arranged at an interval in the circumferential direction along the inner circumferential of the yoke 11. Spaces between the adjacent teeth 12 are referred to as slots 13. The coils 20 are formed of conductive wires which are wound around the teeth 12. In the stator 100, as an example, concentrated winding in which a conductive wire is concentratedly wound around one coil is used. Alternatively, for the coils, distributed winding in which a coil is wound over two teeth 12 separated from each other by a predetermined space can be used.

The stator 100 can be used for a rotary electric machine. The stator 100 with a rotor (not illustrated) can be used as a three-phase AC motor which is used for a travelling drive source or a power generator for an electric vehicle or a hybrid automobile.

(1) Preparation Step

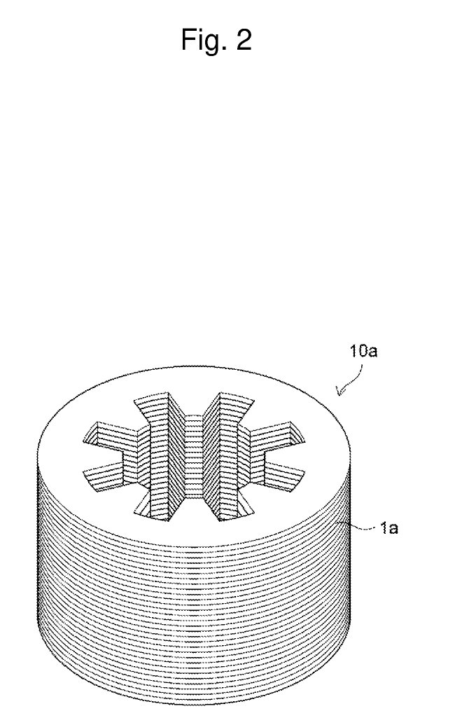

In the present embodiment, as a precursor for a stator core, a stacked body which has teeth and which is formed by stacking a plurality of plate-like soft magnetic materials (also referred to as stator core plates) each including an amorphous structure, is prepared. FIG. 2 is a schematic perspective view of a stacked body 10a formed by stacking a plurality of stator core plates 1a. The stacked body 10a can be formed by stacking the plurality of stator core plates 1a in the axial direction.

Examples of a soft magnetic material to be used for the stator core plates include a material containing at least one magnetic metal selected from a group consisting of Fe, Co, and Ni and containing at least one non-magnetic metal selected from a group consisting of B, C, P, Al, Si, Ti, V, Cr, Mn, Cu, Y, Zr, Nb, Mo, Hf, Ta, and W. However, the soft magnetic material is not limited to such a material. Examples of a representative material for the soft magnetic material include a FeCo-based alloy (e.g. FeCo, FeCoV), a FeNi-based alloy (e.g. FeNi, FeNiMo, FeNiCr, FeNiSi), a FeAl-based alloy or a FeSi-based alloy (e.g. FeAl, FeAlSi, FeAlSiCr, FeAlSiTiRu, FeAlO), a FeTa-based alloy (e.g. FeTa, FeTaC, FeTaN) and a FeZr-based alloy (e.g. FeZrN), and a FeB-based alloy (e.g. FeB, FeBSi). However, the soft magnetic material is not limited to these materials. As another material for the soft magnetic material, a Co alloy containing Co and at least one of Zr, Hf, Nb, Ta, Ti, and Y can be used, for example. In some embodiments, the Co alloy contains at least 80 at % of Co.

The soft magnetic material includes an amorphous structure. In some embodiments, as the soft magnetic material including an amorphous structure, an amorphous-based soft magnetic material or a nanocrystal-based soft magnetic material including an amorphous structure is used. The amorphous-based soft magnetic material is a soft magnetic material having an amorphous structure as the main structure. In an X-ray diffraction pattern of an amorphous structure, no clear peak can be found, and only a broad halo pattern can be observed. A nanocrystalline structure can be formed by performing heating treatment on an amorphous structure. The present embodiment does not use a nanocrystal-based soft magnetic material fully formed of a nanocrystalline structure. However, in some embodiments, a nanocrystal-based soft magnetic material in which an amorphous structure partially remains is used. In the nanocrystal-based soft magnetic material which has a nanocrystalline structure, a diffraction peak is observed at a position corresponding to a diffracting spacing on a crystal surface. The crystallite diameter can be calculated from the width of the diffraction peak by use of the Scherrer equation. A nanocrystal generally refers to a crystal having a crystallite diameter of less than 1 μm, which is calculated from a half-value width of the diffraction peak in X-ray diffraction by use of the Scherrer equation. In some embodiments, the crystallite diameter of a nanocrystal (a crystallite diameter calculated from a half-value width of a diffraction peak in X-ray diffraction on the basis of the Scherrer equation) is 100 nm or smaller, or 50 nm or smaller. In some embodiments, the crystallite diameter of a nanocrystal is 5 nm or larger. When the crystallite diameter of a nanocrystal falls within this range, the soft magnetic characteristics are effectively improved.

For example, a metal raw material formed by blending to have a desired composition is melted at high temperature in a high-frequency melting furnace, etc. so as to become a uniformized molten metal and the molten metal is quickly cooled. As a result, an amorphous-based soft magnetic material can be obtained. Alternatively, the molten metal of the metal raw material is sprayed to a rotating cooling roller so that a thin plate-like (also referred to as thin strip shape) amorphous-based soft magnetic material can be obtained. Further, a nanocrystal-based soft magnetic material can be produced by appropriate additional heating treatment on the amorphous-based soft magnetic material. The condition for the heat treatment is not limited to a particular condition, and is selected, as appropriate, in light of the composition of the metal raw material, the magnetic characteristics to be desired to exhibit, or the like. For example, the temperature during the heat treatment is adjusted to a temperature higher than the crystallization temperature of a soft magnetic material being used. Alternatively, for improvement of a predetermined magnetic characteristic, a nanocrystal may be precipitated in the amorphous-based soft magnetic material. In some embodiments, the heating treatment is performed under an inert gas atmosphere.

In the some embodiments, the degree of crystallinity of the soft magnetic material is 0-90%. When the degree of crystallinity is 90% or lower, the material includes a sufficient amount of an amorphous structure, and thus, the strength of the soft magnetic material is relatively high. Therefore, when the soft magnetic material having the degree of crystallinity of 90% or lower is used, a breakage of the stacked body can be effectively prevented when the coils are mounted thereon. In some embodiments, from the point of view of hardness, the degree of crystallinity of the soft magnetic material is 80% or lower, or 70% or lower.

The degree of crystallinity of the soft magnetic material herein is a value calculated by the following Expression (1) using a caloric value (J/g) of crystallization measured with use of a differential scanning calorimeter (DSC).

Degree of crystallinity (%)=([J_{A}]−[J_{B}])/[J_{A}]×100 Expression (1)

In Expression (1), J_{A} represents a caloric value of crystallization of an amorphous-based soft magnetic material which corresponds to a soft magnetic material to be measured, and J_{B} represents a caloric value of crystallization of the soft magnetic material to be measured.

When the soft magnetic material to be measured is an amorphous-based soft magnetic material, the “amorphous-based soft magnetic material which corresponds to a soft magnetic material to be measured” is the amorphous-based soft magnetic material itself as the soft magnetic material to be measured. Thus, since the value of [J_{A}] is equal to the value of [J_{B}], the degree of crystallinity becomes zero.

When the soft magnetic material to be measured is a nanocrystal-based soft magnetic material, the “amorphous-based soft magnetic material which corresponds to a soft magnetic material to be measured” is prepared by obtaining an amorphous-based soft magnetic material which corresponds to a nanocrystal-based soft magnetic material as the soft magnetic material to be measured. Since the nanocrystal-based soft magnetic material is produced by heating an amorphous-based soft magnetic material, the amorphous-based soft magnetic material before heating is the amorphous-based soft magnetic material which corresponds to a nanocrystal-based soft magnetic material as the soft magnetic material to be measured. Such an amorphous-based soft magnetic material can be easily obtained by a person skilled in the art. Alternatively, the amorphous-based soft magnetic material which corresponds to a nanocrystal-based soft magnetic material can be obtained by heating and melting the nanocrystal-based soft magnetic material at high temperature and then quickly cooling the nanocrystal-based soft magnetic material.

When the degree of crystallinity is 0%, no nanocrystal is precipitated. Thus, the whole material is regarded as an amorphous structure. On the other hand, when the degree of crystallinity is 100%, nanocrystals are precipitated in the entire material. Thus, this state is regarded as a state including no amorphous structure. In order to optimize the saturation magnetization, heating treatment is generally performed until the degree of crystallinity of a material reaches 100%.

In some embodiments, the tensile strength of the soft magnetic material is 1600 MN/m² or more, 1700 MN/m² or more, or 1800 MN/m² or more.

In some embodiments, a surface of the stator core plate is coated with an insulation film. Examples of the insulation film include an oxide film such as SiO₂. The insulation film can reduce a loss caused by eddy current.

In some embodiments, the thickness of the stator core plate is 5-50 μm, or 5-35 μm.

Between the stator core plates, an adhesive layer of a heat resistant resin, etc. may be disposed, or may not be disposed. For example, a thermosetting resin may be used as the heat resistant resin. Examples of the thermosetting resin include an epoxy resin, a polyimide resin, a polyamide-imide resin, and an acrylic resin.

In the stacked body, the stator core plates may be integrally fixed by caulking or welding. For example, the stator core plates may be integrally fixed with bolts each inserted in a through hole provided in the stator core plates.

(2) Mounting Step

Next, the coils are mounted on the teeth of the stacked body.

As a method for winding the coils, concentrated winding in which a one-phase winding wire is wound around one tooth or distributed winding in which a one-phase winding wire is wound over a plurality of teeth, may be used.

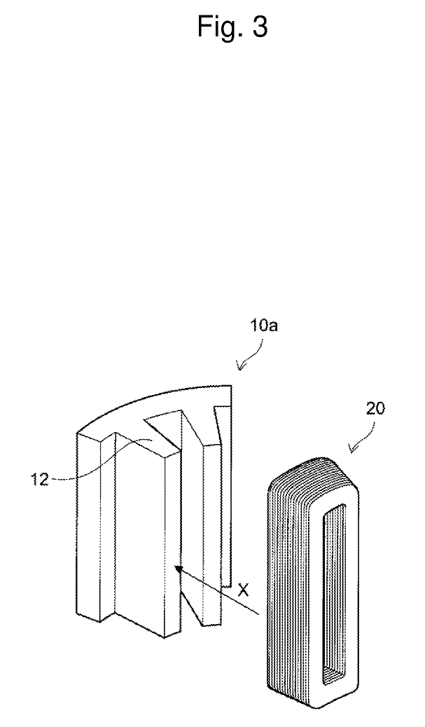

For example, when concentratedly-wound coils are adopted, unit coils (also referred to as cassette coils) having winding wires wound around the corresponding teeth of the stacked body may be prepared in advance. FIG. 3 is a schematic perspective view showing a step of fitting, to the tooth 12, the coil 20 which is wound in advance. For simplification of the drawing, only a part of the stacked body 10a as a precursor for a stator core is illustrated in FIG. 3. In FIG. 3, the coil 20 is formed of a flat rectangular wire, and is formed by edgewise-winding a copper-made flat conductive wire that has an insulation coating formed thereon. The coil 20 (cassette coil) is moved in the arrow X direction and mounted so as to be fitted to the tooth 12.

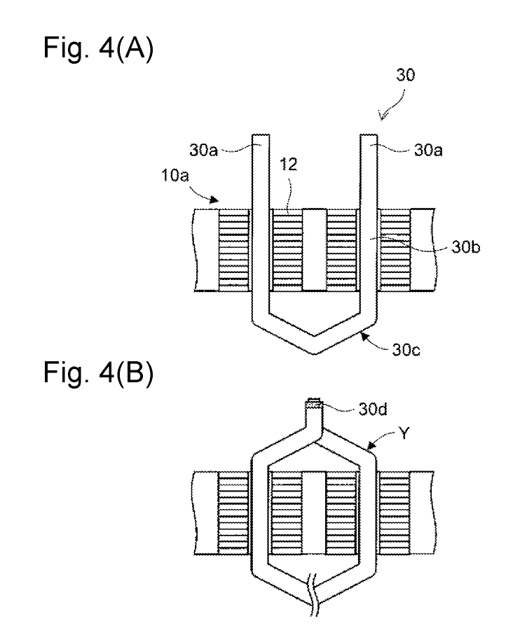

A coil using, as a coil member thereof, a segment 30 having a rectangular conductor edgewise-bent into a substantially U-like shape, as illustrated in FIGS. 4(A) and 4(B), is known. FIGS. 4(A) and 4(B) are schematic perspective views for explaining an example of a step of mounting a U-shaped coil member on a tooth. The segment 30 generally consists of three portions including an in-slot conductive wire portion 30b to be inserted in a slot of a stacked body, a lead portion 30a protruding from an end surface of the stacked body 10a toward the lead side of the stator, and a non-lead portion 30c located on the opposite side, in the stacked body, to the lead portion 30a. FIG. 4(A) is a schematic cross-sectional view of a state in which the segments 30 are inserted in slots. FIG. 4(B) is a schematic cross-sectional view of a state in which, subsequent to the state in FIG. 4(A), the lead portions 30a are bent and welded together. When the coils are mounted, a plurality of radially stacked segments 30 are inserted in the slots in the stacked body 10a having insulators (not illustrated) provided thereon, as illustrated in FIG. 4(A). Subsequently, while the segments 30 are inserted in the slots, the lead portions 30a are bent and the lead portions of adjacent segments are welded together, as illustrated in FIG. 4(B). Accordingly, one coil in which all the segments 30 are continuous to each other is formed. In FIG. 4(B), reference character 30d denotes a welded portion of the lead portions of the segments.

As described above, the coil mounting step involves a process for fitting or bending coils. In the coil mounting step, when a soft magnetic material whose crystallization has been facilitated by heating treatment (annealing) for improving the saturation magnetization are used, a breakage of the stacked body (in particular, a tooth thereof) is easily generated because the strength of the soft magnetic material has been deteriorated by the facilitated crystallization. For example, when the lead portion 30a is bent at a point denoted by Y in FIG. 4(B), a load is applied to a corner of the stacked body so that a breakage may be generated. In contrast, in the present embodiment, the coil is mounted in the state where no heat treatment for improving the saturation magnetization has been performed, that is, in the state where the strength of the soft magnetic materials has not been deteriorated. Therefore, a breakage of the stacked body can be prevented.

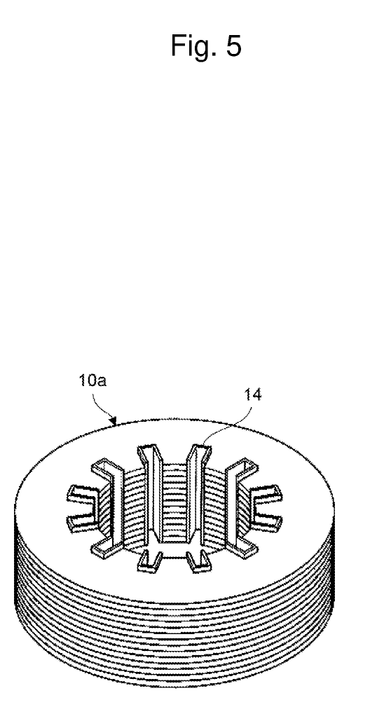

Prior to mounting of the coils, the insulators 14 may be disposed in the slots between the teeth, as illustrated in FIG. 5. The insulators can improve the insulation properties between the coils and the stacked body 10a (or the stator core 10).

(3) Heating Step

After the coils are mounted, the stacked body is heated to a temperature equal to or higher than the crystallization temperature of the soft magnetic material. As a result of heating of the stacked body to a temperature equal to or higher than the crystallization temperature of the soft magnetic material, the crystallization can be facilitated and the saturation magnetization can be improved. The facilitation of crystallization includes generation of crystal and growth of crystal. Also, by this heating, a machining strain generated during pressing can be removed.

In the present embodiment, prior to improvement of the saturation magnetization by heating of the stacked body, the coils are mounted. Therefore, the coils can be mounted in the state where heating has not been performed and the strength is high (that is, in the state where the strength has not been deteriorated by heating). As a result, a breakage of the stacked body is less likely to be generated.

A method for heating the stacked body to a temperature equal to or higher than the crystallization temperature of the soft magnetic material, is not limited to a particular method. For example, a heating furnace may be used. In some embodiments, as the heating method, a method for performing heating by causing high-frequency current to flow through the coils is used. By the high-frequency current flowing through the coils, the stacked body is subjected to high-frequency induction heating. As a result, the stacked body can be easily heated, and further, the stacked body can be selectively induction-heated. Specifically, ends of the coils are connected to a high-frequency current power source, and high-frequency current is caused to flow through the coils. As a result, the coils can function as induction heating coils to perform induction heating on the stacked body.

The crystallization temperature refers to a temperature at which crystallization occurs. As a result of heating to a temperature equal to or higher than the crystallization temperature, the crystallization is facilitated and the saturation magnetization is improved. An exothermic reaction is generated during the crystallization. Thus, the crystallization temperature can be determined by measuring the temperature at which heat generation caused by the crystallization occurs. For example, the crystallization temperature can be measured with use of a differential scanning calorimeter (DSC) under a condition of a predetermined heating rate (e.g. 0.67 Ks⁻¹). The crystallization temperature of the soft magnetic material depends on the material properties thereof, but is 330-430° C., for example.

Heating is performed such that the temperature of the stacked body is increased to the crystallization temperature of the soft magnetic material or higher. The heating temperature (the temperature of the stacked body being heated) is not limited to a particular temperature as long as the heating temperature is equal to the crystallization temperature or higher. For example, the heating temperature is 330° C. or higher. In some embodiments, the heating temperature is 400° C. or higher. Adjustment of the heating temperature to 400° C. or higher can result in facilitation of efficient crystallization. Further, In some embodiments, heating is performed such that the temperature of the stacked body is not increased to a temperature at which a by-product of the soft magnetic material is generated. When the heating temperature is excessively high, an undesired by-product (e.g. Fe₂B) may be generated in the core material. Generation of such a by-product can be checked by a differential scanning calorimeter (DSC) or by XRD, for example. Accordingly, In some embodiments, the heating temperature is 550° C. or lower, 520° C. or lower, or 500° C. or lower. A heat treatment temperature of 550° C. or lower can facilitate prevention of excessive crystallization and can suppress occurrence of a by-product.

In some embodiments, the heating treatment is performed until the aforementioned degree of crystallinity reaches 100%. When the degree of crystallinity is 100%, the saturation magnetization can be efficiently improved. Further, In some embodiments, the heating treatment is performed until the saturation magnetization becomes the maximum. The maximum value of the saturation magnetization varies depending on the type of a soft magnetic material. The maximum value of saturation magnetization and the amount of heat required to reach the maximum value can be confirmed through an experiment, etc. in advance by a person skilled in the art.

By the aforementioned heating step, the stacked body is heated so as to have desired magnetic characteristics, that is, desired saturation magnetization, and thus, a stator is formed.

In addition to the aforementioned steps, any other step may be performed on the obtained stator. For example, tip ends of the bolts used for fixation may be screwed in screw holes formed in a housing (not illustrated). As a result, the stator can be fixed to the housing.

### EXAMPLES

### Example 1

An amorphous plate (thickness: 25 μm, crystallization temperature: 391° C., degree of crystallinity: 0%, tensile strength: 1861 MN/m²) was prepared, the amorphous plate was punched with use of a press die, and thus, stator core plates were produced. Since the amorphous-based soft magnetic material was used for the stator core plates, the degree of crystallinity thereof was 0%. The crystallization temperature was identified by measurement of the exothermic reaction starting temperature with use of a differential scanning calorimeter (DSC) under the condition in which the heating rate was 0.67 Ks⁻¹.

Next, the stator core plates were stacked, were fastened with bolts, and thus, a stacked body was produced. In addition, insulators were inserted in slots of the stacked body.

Next, as illustrated in FIGS. 4(A) and 4(B), a plurality of stacked segments were inserted in the slots, the lead portions thereof were bent, and the adjacent lead portions were welded together, whereby the coils were mounted on the teeth.

Next, ends of the coils were connected to a high-frequency power source, and high-frequency current was caused to flow through the coils. In this way, the stacked body was heated at 475° C. for three seconds by high-frequency induction heating. By this heating treatment, the saturation magnetization was improved to the maximum.

In the present example, no breakage was generated when the coils were mounted, and a stator having the saturation magnetization improved by the heating treatment was obtained.

### Example 2

A nanocrystal plate (thickness: 25 μm, degree of crystallinity: 90%, tensile strength: 1820 MN/m²) was prepared, and the nanocrystal plate was punched into a stator core plate with use of a press die.

The degree of crystallinity thereof was calculated, by Expression (1), from a caloric value (J/g) of crystallization measured with a differential scanning calorimeter (DSC). As the “amorphous-based soft magnetic material which corresponds to a soft magnetic material to be measured”, an amorphous plate (i.e. the amorphous plate used in Example 1) before heat treatment of the nanocrystal plate (heat treatment for generating a nanocrystal) was used.

The stator core plates thus obtained were used and heated at 430° C. for three seconds. Except for this, the same process as Example 1 was performed to produce a stator.

In the present example, no breakage was generated when the coils were mounted, and a stator having the saturation magnetization improved by the heating treatment was obtained.

### Comparative Example

A nanocrystal plate (thickness: 25 μm, degree of crystallinity: 100%, tensile strength: 1530 MN/m²) was prepared, and the nanocrystal plate was punched into a stator core plate with use of a press die.

The degree of crystallinity thereof was calculated, by Expression (1), from a caloric value (J/g) of crystallization measured with a differential scanning calorimeter (DSC). As the “amorphous-based soft magnetic material which corresponds to a soft magnetic material to be measured”, an amorphous plate (i.e. an amorphous plate the same as that used in Example 1) before heat treatment of a nanocrystal plate (heat treatment for generating a nanocrystal) was used. The nanocrystal plate was fully crystallized and included no amorphous structure.

Next, the stator core plates were stacked, were fastened with bolts, and thus, a stacked body was produced. In addition, insulators were inserted in slots in the stacked body.

Next, as illustrated in FIGS. 4(A) and 4(B), a plurality of stacked segments were inserted in the slots, the lead portions thereof were bent, and the adjacent lead portions were welded together, whereby the coils were mounted on the teeth.

However, the lead portions were bent, loads were applied to the stacked body, and thus, a damage was generated.

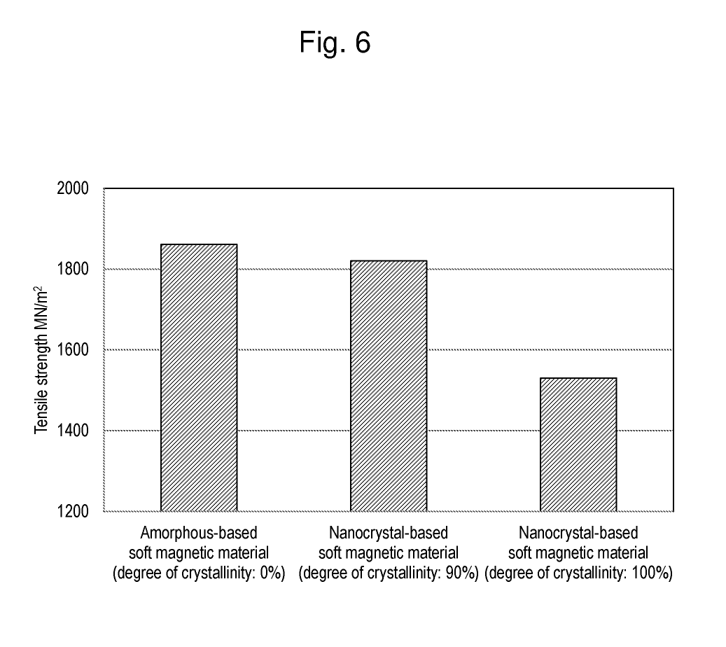

FIG. 6 shows the tensile strength of the amorphous plate used in Example 1, the tensile strength of the nanocrystal plate (degree of crystallinity: 90%) used in Example 2, and the tensile strength of the nanocrystal plate (degree of crystallinity: 100%) used in Comparative Example. This data shows that when the degree of crystallinity was 0-90%, the strength was high, and when the degree of crystallinity was 100%, the strength was lower.

The embodiment of the present invention has been described above in detail with reference to the drawings. The specific configuration of the present invention is not limited to the above embodiment. The present invention encompasses a design change, etc. within the scope of the gist of the present invention.

### DESCRIPTION OF SYMBOLS

10 Stator core
10a Stacked body (precursor for a stator core)
11 Yoke
12 Tooth
13 Slot
14 Insulation film
20 Coil
30 Segment
30a Lead portion
30b In-slot conductive wire portion
30c Non-lead portion
30d Welded portion
100 Stator

What is claimed is:

1. A production method for a stator that includes a stator core having a tooth and includes a coil wound around the tooth, the method comprising:
a step of preparing a stacked body which has the tooth and in which a plurality of plate-like soft magnetic materials each including an amorphous structure are stacked;
a step of mounting the coil on the tooth; and
a step of, after the coil is mounted, heating the stacked body to a temperature equal to or higher than a crystallization temperature of the soft magnetic materials.

2. The production method according to claim 1, wherein
the stacked body is heated by high-frequency current flowing through the coil.

3. The production method according to claim 1, wherein
each of the soft magnetic materials is an amorphous-based soft magnetic material or a nanocrystal-based soft magnetic material including an amorphous structure.

4. The production method according to claim 3, wherein
a degree of crystallinity of each of the soft magnetic materials is 0-90%.
